(19) United States
(12) Patent Application Publication
(10) Pub. No.: US 2006/0101210 A1
(43) Pub. Date: May 11, 2006

(54) Register-based memory command architecture

(76) Inventor: Lance Dover, Fair Oaks, CA (US)

Correspondence Address: INTEL CORPORATION, P.O. BOX 5326, SANTA CLARA, CA, 95056-5326, US

(21) Appl. No.: 10/966,707

(22) Filed: Oct. 15, 2004

(51) Int. Cl. G06F 12/14

(52) U.S. Cl. 711/154

(57) ABSTRACT

A device and method for interfacing a processor to a non-volatile memory that may use a command based architecture to receive data from the processor and a long latency architecture that includes a microcode engine within the memory to control simple read, erase and program operations and further capable of controlling complex functions.

Nonvolatile memory circuits typically use a command based architecture where individual commands are issued by the processor for execution by the memory device. Using this architecture, memory devices may decode received commands to program and retrieve stored data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless system that incorporates a flexible and simplified scheme used to interface the processor with the system memory;

FIG. 2 is a diagram that illustrates the processor accessing the memory core using the multiple addressable registers in accordance with the present invention; and

FIG. 3 is a flow diagram illustrating use of an address register, a data register, a byte count register and a command register to control operation of the memory device.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

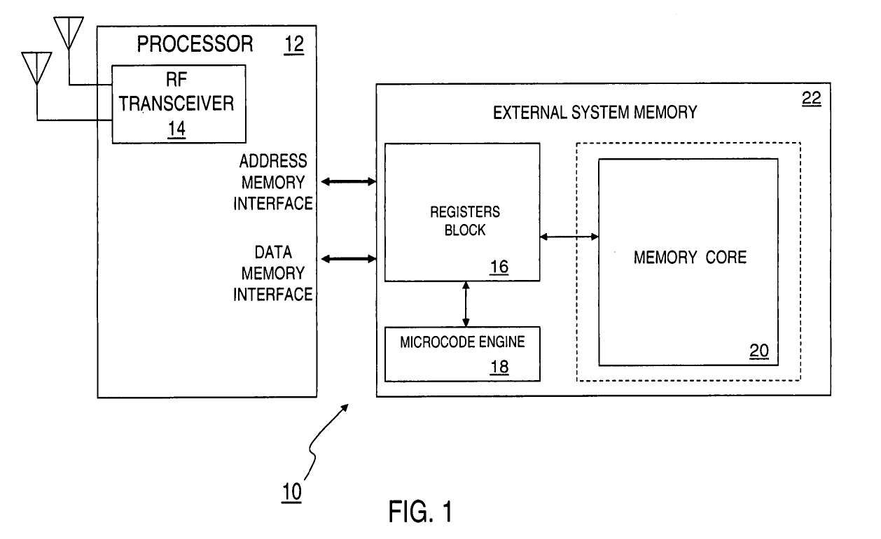

FIG. 1 illustrates features of the present invention that may be incorporated, for example, into a wireless communications device 10, although the claimed subject matter of the present invention may be used in other applications. In the wireless communications embodiment, a transceiver 14 both receives and transmits a modulated signal from one or more antennas. The analog front end transceiver may be a stand-alone Radio Frequency (RF) integrated analog circuit, or alternatively, be embedded with a processor 12 as a mixed-mode integrated circuit. The received modulated signal may be frequency down-converted, filtered, then converted to a baseband, digital signal. Processor 12 may include baseband and applications processing functions, and in general, be capable of fetching instructions, generating decodes, finding operands, performing the appropriate actions and storing results.

The digital data processed by processor 12 may be stored internally in an embedded memory or transferred across an interface for storage by a system memory 22. System memory 22 may include a variety or combination of memories. As such, the storage devices may be volatile memories such as, for example, a Static Random Access Memory (SRAM), a Dynamic Random Access Memory (DRAM) or a Synchronous Dynamic Random Access Memory (SDRAM), although the scope of the claimed subject matter is not limited in this respect. In other embodiments, the memory devices may be nonvolatile memories such as, for example, an Electrically Programmable Read-Only Memory (EPROM), an Electrically Erasable and Programmable Read Only Memory (EEPROM), a Flash memory, a Ferroelectric Random Access Memory (FRAM), a Polymer Ferroelectric Random Access Memory (PFRAM), a Magnetic Random Access Memory (MRAM), an Ovonics Unified Memory (OUM) or any other device capable of storing instructions and/or data. However, it should be understood that the scope of the present invention is not limited to these examples.

Embodiments of the present invention for system memory 22 utilize a register block 16 and/or dedicated memory portions that control accesses to a memory core 20. Although not shown, note that the contents of the registers in block register 16 may be readable to facilitate test processes and provide a lower pin count memory device. The register block 16 includes memory software that is locally executed by microcode engine 18 within system memory 22 to provide applications in smart phones, communicators and Personal Digital Assistants (PDAs), medical or biotech equipment, automotive safety and protective equipment, and automotive infotainment products. However, it should be understood that the scope of the present invention is not limited to these examples.

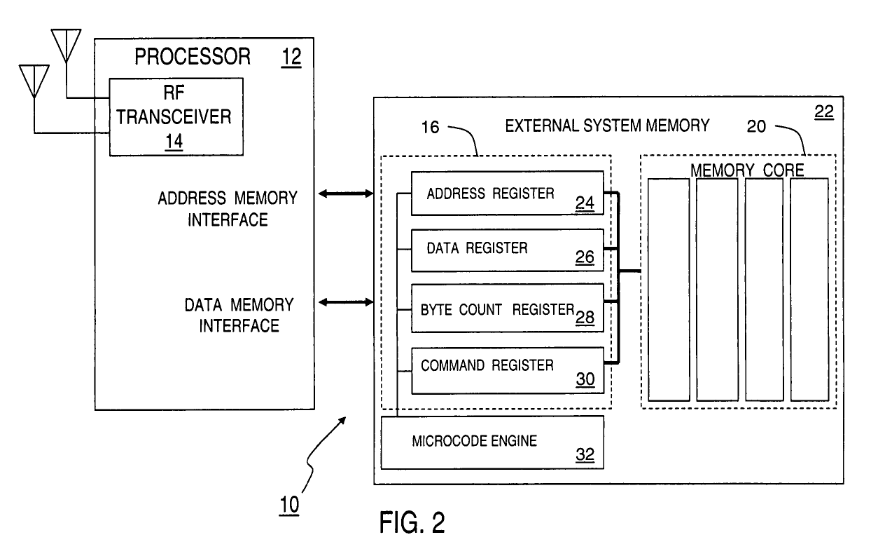

FIG. 2 is a diagram that illustrates the use of register block 16 in allowing processor 12 to store and access data to/from memory core 20 in a flexible and simplified approach in accordance with the present invention. System memory 22 includes a plurality of control lines, address lines, and data lines that interface with processor 12 and allow the electronic devices to communicate and share data. Processor 12 provides addresses and data to system memory 22 to fill the contents of an address register 24, a data register 26, a byte count register 28, and then supplies a command to a command register 30. It should be pointed out that system memory 22 is not limited to address, data and command registers and other configuration registers may be included.

In particular, address register 24 stores address data associated with command instructions while data register 26 stores data associated with command instructions. Byte count register 28 stores data that contains data units or count values, or in general, a numerical value. Note that address register 24, data register 26 and byte count register 28 may be loaded in any order, with command register 30 purposely being loaded after the other registers. Command register 30 stores a command that may be interpreted as a specific memory command such as, for example, a program command or an erase command. Once the loaded command is interpreted by microcode engine 18, the command may be supplemented with additional command instructions or a sequence of commands without the intervention of processor 12.

Some memories such as Flash memories service some memory operations with a bus cycle latency while other memory operations such as program and erase operations take more time. The disparity in time between various memory operations favors the architecture illustrated in FIG. 2 that utilizes a flexible internal microcode to implement memory operations. By providing a “long” latency architecture controlled by microcode, each command may be parsed and serviced, while allowing the processor to perform and complete operations that are transparent to the memory device. The “long” latency architecture is beneficial for nonvolatile memory devices and allows error handling, power management and other processing functions within the device. Thus, whereas traditional prior art operations (such as the read and write operations) complete operations within one bus cycle, the “long” latency architecture provides a desired flexibility to manage tasks without processor 12 intervention. The “long” latency architecture may allow commands, whether simple commands like reads and writes or complex commands having multi-step operations that utilize multiple bus cycles to provide system memory 22 with increased flexibility. Complex commands may address security issues, for example.

Note that the architecture techniques of the present invention do not require a state machine to provide and manage memory instructions, and therefore, the silicon area required by the hard-coded state machine can be saved. Further, the architecture techniques of the present invention free the processor from managing memory operations. The architecture employed in this invention provides a system memory whose functionality is defined by uCode. Specifically for non-volatile memories that uCode may be modified to provide particular, desired commands. In other words, command configuration data may be programmed, and even modified, to provide system memory 22 degrees of flexibility when interfacing with processor 12. This feature that allows microcode updates after the memory has been processed provides products amenable to new device characteristics or functionality.

Again, one embodiment of the present invention allows processor 12 to pre-load address register 24, data register 26 and byte count register 28, then receive a command to command register 30. Upon loading command register 30, additional commands appropriate to the loaded command may then be sequentially executed under local software or uCode control without intervention from processor 12. The commands use the address data in address register 24 and the data stored in data register 26. Thus, system memory 22 allows a command issued by processor 12 to autonomously perform various tasks and free the processor from the burden of having to control specific tasks that are internal to system memory 22.

Another embodiment of system memory 22 utilizes non-volatile memory storage that is allocated to storing address information, data, byte count data and commands (instead of a physical register section). The uCode in the non-volatile memory storage may easily be programmed, then modified or updated to provide other desired commands. This embodiment also provides the flexibility of allowing system memory 22, under local software or uCode control, to free processor 12 from managing and controlling specific tasks preformed internally by the memory. The “long” latency architecture employed by system memory 22 frees the processor from controlling the memory device every bus cycle, even through operations are being performed and completed by the memory device concurrent with operations within the processor. Again, the “long” latency architecture allows the nonvolatile memory device to handle processing functions within the device without adhering strictly to processor based bus cycles.

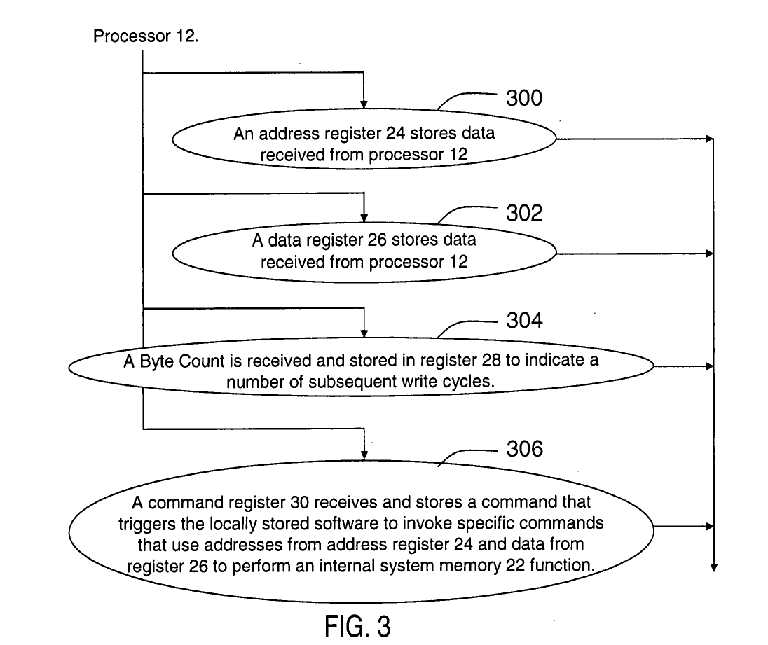

FIG. 3 is a flow diagram showing the architecture that allows processor 12 to interface with system memory 22. System memory 22 receives address data from processor 12 (block 300) for storage in address register 24 and data for storage in data register 26 (block 302). A Byte Count value is received and stored in register 28 (block 304). Although address register 24, data register 26 and byte count register 28 may be loaded in any order, note that command register 30 is loaded last (block 306). The received command triggers the locally stored software to invoke specific commands that use addresses from address register 24 and data from register 26 to perform internal system memory 22 functions. FIG. 3 is also applicable for showing the process flow when address information, data, byte count data and commands are stored in memory cells of the non-volatile memory.

By now it should be apparent that the present invention enhances execution of instructions by a memory that interfaces with a processor. The present invention uses a register interface to accept read and write commands based on a bus cycle latency, and utilizes microcode to interpret complex commands and perform operations using a long latency architecture to provide functionality not based on the bus cycle latency.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A memory device, comprising:
a register interface to accept commands based on a bus cycle latency; and
microcode to perform simple commands and read and interpret complex commands using a long latency architecture to provide functionality not based on the bus cycle latency.

2. The memory device of claim 1, further comprising:
an address register coupled to the register interface to receive an address;
a data register coupled to the register interface to receive data; and
a byte count register coupled to the register interface to receive a value that indicates a number of subsequent write cycles.

3. The memory device of claim 1 further comprising:
a command register to receive a command.

4. The memory device of claim 3 wherein the microcode interprets the command in the command register to initiate programming the memory device.

5. The memory device of claim 3 wherein the microcode interprets the command in the command register to initiate reading the memory device.

6. The memory device of claim 3 wherein the microcode interprets the command in the command register to initiate erasing the memory device.

7. The memory device of claim 1 further including a Flash memory.

8. A system comprising:
a processor;
a transceiver coupled to the processor;
first and second antenna coupled to the transceiver; and
a non-volatile memory having registers coupled to receive a command in accordance with a bus cycle of the processor, where microcode within the non-volatile memory initiates and completes operations not based on the bus cycle of the processor.

9. The system of claim 8 wherein the microcode interprets the command based on a long latency architecture of the non-volatile memory.

10. The system of claim 8 wherein the non-volatile memory is a NOR-flash memory.

11. The system of claim 8 wherein the non-volatile memory further includes:
an address register coupled to an address interface to receive an address;
a data register coupled to a data interface to receive data;
a byte count register coupled to the data interface to receive a value that indicates a number of subsequent write cycles; and
a command register to receive a command to initiate programming the non-volatile memory.

12. A method for interfacing a processor to a non-volatile memory comprising:
issuing commands from the processor based on a processor bus cycle to store in registers of the non-volatile memory; and
performing non-volatile memory operations using microcode to read the commands and initiate operations that complete irrespective of the processor bus cycle, wherein the non-volatile memory has a long latency architecture.

13. The method of claim 12 wherein storing commands in the registers of the non-volatile memory further includes:
writing an address register, a data register, a byte count register and a command register in the non-volatile memory from the processor, each write using one bus cycle.

14. The method of claim 12 wherein the long latency architecture includes:
issusing the commands for multi-step operations that take more than one processor bus cycle to complete.

15. The method of claim 12 further including using a NOR flash memory as the non-volatile memory.

16. The method of claim 15 further including re-programming a portion of the NOR flash memory to alter commands issued by the microcode.

17. A method of interfacing a nonvolatile memory device to a processor comprising:
utilizing memory cells within the nonvolatile memory device to store commands, wherein the commands are transferred from the processor to the nonvolatile memory device using a bus cycle of the processor; and
using a long latency architecture in the nonvolatile memory device that allows microcode to interpret the commands and complete command operations independent of the bus cycle of the processor.

18. The method of claim 17 further including:
re-programming the instructions stored in the memory cells to alter command operations as interpreted by the microcode in the nonvolatile memory device.

19. The method of claim 17 wherein using a long latency architecture in the nonvolatile memory device further includes:
interpreting the commands for multi-step operations.

20. The method of claim 17 wherein using a long latency architecture further includes:
completing at least one of the commands stored in the nonvolatile memory device in a time that is more than one bus cycle of the processor.
